(19) United States
(12) Patent Application Publication
(10) Pub. No.: US 2009/0293227 A1
(43) Pub. Date: Dec. 3, 2009

(54) UNIVERSAL-JOINT ROLLER FOR AN EXERCISE APPARATUS

(76) Inventor: Leao Wang, Taichung (TW)

Correspondence Address: Leao Wang, 13F, No. 23, Jiun-Ho Street, Beitun District, Taichung, 406, omitted

(21) Appl. No.: 12/131,933

(22) Filed: Jun. 3, 2008

(51) Int. Cl. B60B 33/08

(52) U.S. Cl. 16/26

(57) ABSTRACT

A universal-joint roller for an exercise apparatus includes a main body, a ball roller, and an arresting ring. The main body has a connecting bar at one end thereof and a receiving portion at the other end thereof. Three layers of ball grooves are disposed within the receiving portion for receiving several balls in certain position to enclose the circumference of the ball roller. Thereafter, the ball roller is received by the hollow arresting ring in position such that the ball roller is exposed from the arresting ring to achieve an expected rolling movement in all directions.

### BACKGROUND OF THE INVENTION

1. Fields of the Invention

The invention relates to a universal-joint roller for an exercise apparatus, and more particularly, to a structure for facilitating the movement of the exercise apparatus in all directions, thereby achieving the expected convenience and practicalness.

2. Description of the Related Art

As we all know, most of the indoor fitness equipment (such as electric treadmills, fitness bikes, elliptical motion machines, rowing exercisers, stepping exercisers, weightlifting sets, etc.) are made of metal material. They usually have huge volume and therefore have great weight. It must take up great effort when an operator moves or turns them. In order to avoid the above-mentioned problem, at least one wheel assembly 60 is installed at a ground-touching support foot (see FIG. 4) for facilitating the movement in all direction.

The conventional wheel assembly 60 includes a wheel shaft 61. Therefore, this conventional product is only suitable for the forward and backward movement of the wheel rather than for the turning movement. The problem of the turning movement can be resolved by a pivotal structure. However, the huge weight of the exercise apparatus must cause the operator difficulties and inconvenience in moving it.

### SUMMARY OF THE INVENTION

An object of the invention is to provide a universal-joint roller without a wheel shaft to conduct the movement in all directions, thereby ensuring a labor saving, smooth, and convenient effect.

According to the invention, a universal-joint roller for an exercise apparatus includes a main body, a ball roller, and an arresting ring. The main body has a connecting bar at one end thereof and a receiving portion at the other end thereof. Three layers of ball grooves are disposed within the receiving portion for receiving several balls in certain position to enclose the circumference of the ball roller. Thereafter, the ball roller is received by the hollow arresting ring in position such that the ball roller is exposed from the arresting ring to achieve an expected rolling movement in all directions.

### BRIEF DESCRIPTION OF THE DRAWINGS

The accomplishment of this and other objects of the invention will become apparent from the following description and its accompanying drawings of which:

FIG. 1 is an exploded perspective view of a universal-joint roller in accordance with the invention;

FIG. 2 is a schematic drawing of the universal-joint roller in accordance with the invention after assembly;

FIG. 3 is a partial cross-sectional view of the universal-joint roller in accordance with the invention; and

FIG. 4 is a preferred application embodiment of the universal-joint roller in accordance with the invention.

### DETAILED DESCRIPTION OF THE PREFERRED EMBODIMENT

The present invention will now be described in more detail hereinafter with reference to the accompanying drawings that show various embodiments of the invention.

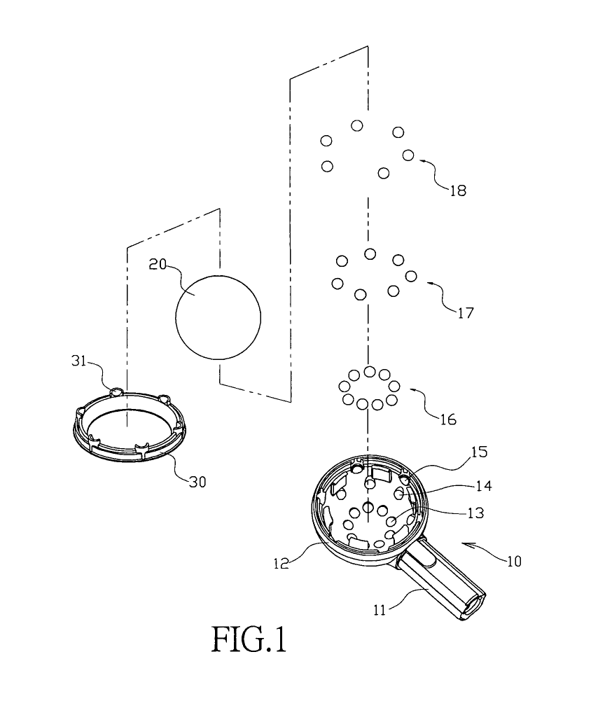

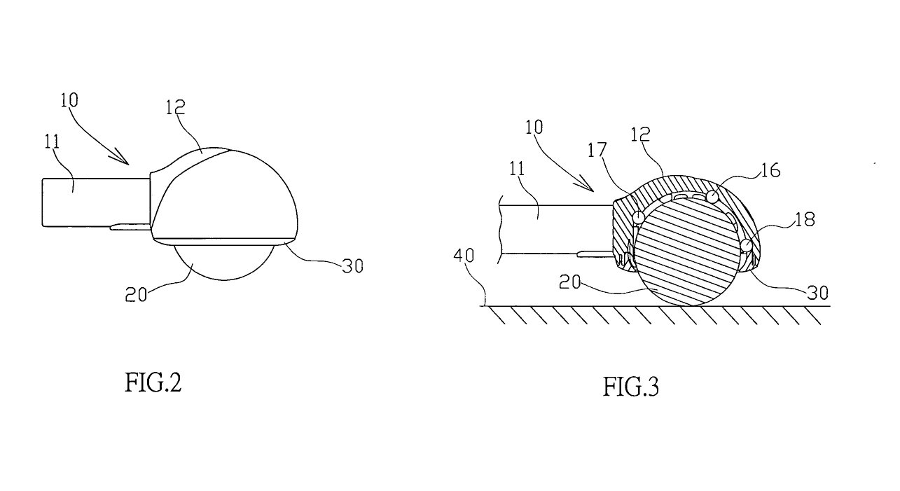

Referring to FIGS. 1 through 3, a universal-joint roller for an exercise apparatus in accordance with the invention includes a main body 10, a ball roller 20, and an arresting ring 30.

The main body 10 has a connecting bar 11 at one end thereof for attaching to a certain support foot of an exercise apparatus and a receiving portion 12 at the other end thereof. A first-layer ball groove 13, a second-layer ball groove 14, and a third-layer ball groove 15 are disposed within the receiving portion 12 for receiving first-layer balls 16, second-layer balls 17, and third-layer balls 18 in a certain amount as well as in certain position to enclose the circumference of the ball roller 20

The ball roller 20 is formed in a ball shape and received within the receiving portion 12 of the main body 10.

The arresting ring 30 is formed in a ring shape and attached to the main body 10 for locking the ball roller 20 in place. A third-layer ball groove 31 is formed at a position opposing to the third-layer ball groove 15 of the main body 10 for working together to receive and lock the third-layer balls 18 in position.

Based on the assembly of the above-mentioned components, the ball roller 20 can be exposed from the arresting ring 30 to achieve an expected rolling movement in all directions.

The assembly of the above-mentioned components is illustrated in FIG. 3. The first-layer balls 16 are just situated at the top of the ball roller 20 (relative to the ground 40). The second-layer balls 17 are positioned at the neck portion of the ball roller 20 while the third-layer balls 18 are located at the waist portion in the middle of the ball roller 20. In this way, it is avoided that the ball roller 20 is in contact with any portion of the circumference of the receiving portion 12 of the main body 10. As a result, a free rolling movement of the ball roller 20 on the ground 40 is ensured. Moreover, the arresting ring 30 is at a position covering more than a half of the ball roller 20 such that an effective protection of the ball roller 20 from being dropping off is achieved.

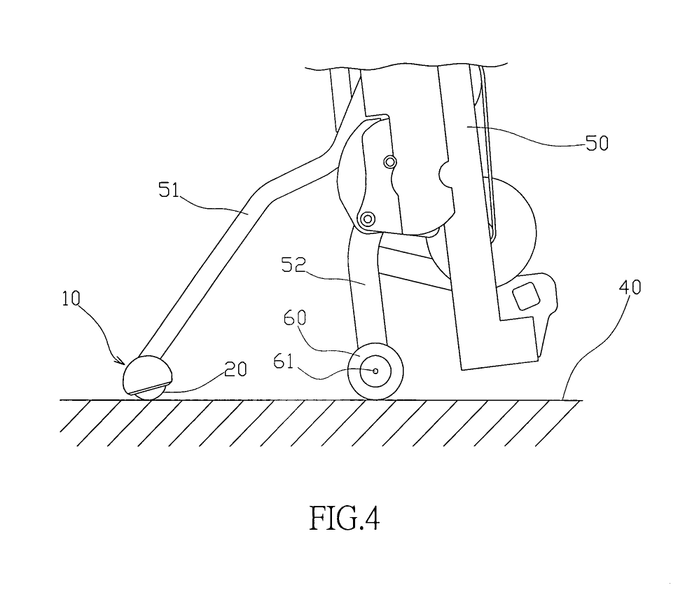

Referring to FIG. 4, which illustrates a preferred embodiment of the invention applied to an electric treadmill 50, the universal-joint roller in accordance with the invention is installed at a distal end of a certain auxiliary support foot. That is, the universal-joint roller works in match of a conventional wheel assembly 60 fitted with a wheel shaft 61 and installed at a front support 52 of the electric treadmill 50 for a free movement in all directions on the ground 40

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A universal-joint roller for an exercise apparatus, comprising a main body, a ball roller, and an arresting ring,
wherein a main body has a connecting bar at one end thereof for attaching to a certain support foot of an exercise apparatus and a receiving portion at the other end thereof; and a first-layer ball groove, a second-layer ball groove, and a third-layer ball groove are disposed within the receiving portion for receiving first-layer balls, second-layer balls, and third-layer balls in a certain amount as well as in certain position to enclose the circumference of the ball roller;
wherein the ball roller is formed in a ball shape and received within the receiving portion of the main body; and
wherein the arresting ring is formed in a ring shape and attached to the main body for locking the ball roller in place, and a third-layer ball groove is formed at a position opposing to the third-layer ball groove of the main body for working together to receive and lock the third-layer balls in position.
whereby, based on the assembly of the above-mentioned components, the ball roller can be exposed from the arresting ring to achieve an expected rolling movement in all directions.
